(19) United States
(12) Patent Application Publication
(10) Pub. No.: US 2003/0046256 A1
(43) Pub. Date: Mar. 6, 2003

(54) Distributed information management

(76) Inventors: Ola Hugosson, Lund (SE); Stefan Burstrom, Lund (SE); Petter Ericson, Malmo (SE); Roger Astrom, Stockholm (SE); Jan Andersson, Sunnyvale, CA (US)

Correspondence Address: NORMAN H. ZIVIN, Cooper & Dunham LLP, 1185 Avenue of the Americas, New York, NY, 10036, US

(21) Appl. No.: 09/746,780

(22) Filed: Apr. 20, 2001

Related U.S. Application Data
(60) Provisional application No. 60/177,310, filed on Jan. 21, 2000.
(60) Provisional application No. 60/208,164, filed on May 31, 2000.
(60) Provisional application No. 60/208,169, filed on May 31, 2000.
(60) Provisional application No. 60/208,170, filed on May 31, 2000.
(60) Provisional application No. 60/210,654, filed on Jun. 9, 2000.

(30) Foreign Application Priority Data
Dec. 23, 1999 (SE) 9904745-8
Feb. 18, 2000 (SE) 0000541-3
Mar. 21, 2000 (SE) 0000939-9
Mar. 21, 2000 (SE) 0000952-2
Apr. 5, 2000 (SE) 0001239-3
Aug. 3, 2000 PCT/SE00/01667

(51) Int. Cl. G06F 17/30

(52) U.S. Cl. 707/1

(57) ABSTRACT

A system for information management comprises a look-up unit (4), in which are stored particulars about a plurality of regions (5′), each of which represents an area on at least one imaginary surface (5) and is allocated an address. A user unit (2) records electronically information which comprises one or more positions on the imaginary surface (5) and sends all or parts of the recorded information to the look-up unit (4). When the look-up unit (4) receives the recorded information, it identifies, based on the position content of the recorded information, a region (5′) on the imaginary surface (5) and sends the address which is allocated to the identified region to the user unit (2).

A look-up unit, a user unit, a computer program and a method for information management are also described.

### FIELD OF THE INVENTION

This invention relates to the field of management and communication of information.

### BACKGROUND OF THE INVENTION

Information is often written down and communicated by means of pen and paper. Such paper-based information is, however, difficult to manage and communicate efficiently.

Computers are used to an increasing extent for managing and communicating information. The information is entered by means of a keyboard and stored in the computer's memory, for example on a hard disk. The entry of the information by means of the keyboard is, however, slow and it is easy to make mistakes. Nor is it particularly convenient to read large amounts of text on a computer screen. Graphical information, such as drawings or images, is usually entered by means of a separate image reader, such as a scanner or the like, in a procedure which is time-consuming, cumbersome, and as often as not gives unsatisfactory results. However, once the information is in the computer, it is easy to communicate it to others, for example as an e-mail or SMS via an Internet connection or as a fax via a fax modem.

In Applicant's Patent Application PCT/SE00/01895, which claims priority from Swedish Patent Application No. 9903541-2, filed on Oct. 1, 1999, and which is incorporated herein by reference, a system is described where a pen and paper are used to write down information in the traditional way, where at the same time a digital graph is created consisting of several tracks or lines of the movement of the pen across the paper, which graph can be transmitted to a computer. Such a system combines the advantages of management with pen and paper, which many users are used to, with the computer's superior ability to communicate and store information. The sheet of paper is provided with a coding pattern, for example consisting of points or other symbols. The pen has a sensor, preferably optical, which records the coding pattern and, by means of a mathematical algorithm, calculates the position of the pen on the coding pattern.

In this way, the traditional pen becomes an excellent input device for the computer, and the computer can be used to store the recorded information instead of the sheet of paper having to be archived in a file. In addition, the information can easily be communicated by means of the computer.

The recorded information contains parts which can be used for different purposes.

1) The digital graph contains an image, such as figures or interrelated lines, which can be interpreted by people, for example letters, a symbol, a figure or a drawing. This is the actual message which was written down and which the user wants to manage in some way, for example to archive or to send to a recipient. This information, so-called message information, is stored in some graphical format, for example a vector format or as a collection of pixels.

2) The part of the message information which consists of letters (handwritten) can be subjected to subsequent processing in the form of OCR interpretation (Optical Character Recognition) or ICR interpretation (Intelligent Character Recognition) for conversion into a character format which can be used by the computer, for example for searching purposes or for cataloguing. Symbols can also be interpreted, for example stenography symbols or icons, to which the user predefines a particular meaning. In the following, this information is called character information.

3) The information can also contain an identification of which pen was used to write down the information.

4) Finally, the graph contains information about where on the surface the graph was written down, socalled absolute position information.

5) In addition, a hard copy of the recorded information can be obtained, if the pen makes physical marks on the sheet of paper.

Prior-art technique comprises other systems for obtaining absolute or relative position information when writing on a surface. However, these previously known systems only describe the use of such information in order to create message information and/or character information, that is information belonging to the groups 1) and 2) above. Such prior-art technique includes, for example, optical detection of a position-coding pattern on a base, as described in U.S. Pat. Nos. 5,051,736, 5,442,147, 5,852,434, 5,652,412 and EP-B-0 615 209. Position information can also, as also described in EP-B 0 615 209, be obtained by means of acceleration sensors, or by means of inductive/capacitive/magnetic sensors. Other alternatives are a base incorporating pressure sensors, as described in U.S. Pat. No. 5,790,105, triangulation of signals (light, sound, infrared radiation, etc.) with the use of a plurality of transmitters/receivers, as described in U.S. Pat. No. 5,012,049, or mechanical detection of movement relative to a surface, as described in U.S. Pat. No. 4,495,646. Position information can also be obtained by combinations of techniques. For example, a system is described in WO 00/31682 with combined optical detection of symbols, for determination of absolute position information at low resolution, and acceleration sensors, for determination of relative position information at high resolution.

Although, according to prior art, there are several different techniques for recording message and/or character information as described above, there is no system for enabling the user to manage this information in a simple, flexible and structured way. For example, a user may want to send all or parts of the recorded information to a recipient.

### SUMMARY OF THE INVENTION

An object of this invention is to solve completely or partially the above-mentioned problems. More specifically, it is an object of this invention to improve the management of information which is recorded digitally by means of a user unit.

It is also desirable to show a technique for information management that is easy for the user to use.

A further object is to achieve a technique which enables rapid, simple and unambiguous management of information.

It is also an object to achieve a technique which is general, but which permits individual handling of different parties' information.

These and other objects, which will be apparent from the following description, have now been achieved completely or partially by a system for managing information according to claim 1, a look-up unit according to claim 29, a user unit according to claim 32, a computer program according to claim 38 and a method for information management according to claim 39. Preferred embodiments are defined in the dependent claims.

According to a first aspect of this invention, more specially a system for information management is achieved comprising a look-up unit, in which particulars or data are stored about a plurality of regions, each of which represents an area on at least one imaginary surface and is allocated an address; and a user unit which is arranged to record electronically information which comprises at least one position on the imaginary surface and to send said at least one position to the look-up unit, the look-up unit being arranged, in response to the receipt of said at least one position from the user unit, to identify to which region said at least one position belongs and to send the address which is allocated to the identified region to the user unit.

The imaginary surface has the general property that it contains or is made up by a large number of positions. A database which contains the imaginary surface can be searched on the basis of these positions. If such an imaginary surface is divided into regions, each of which is allocated particular properties, and if such regions are coded physically on products for recording information, the information later recorded on the products can be managed depending upon its location on the imaginary surface. The coding of the regions on the products can be carried out by one of the above known techniques for obtaining position information when writing on a surface.

The invention is based on the idea that the positions on the imaginary surface can be used both to record electronically handwritten information and to control where the recorded information is to be sent. This is achieved by dividing the imaginary surface into regions and allocating each such region an address. For example, a particular party can have the sole right to a particular region and can direct the information which is recorded on his region to a particular address. The system is thus easy to use and gives increased opportunities for managing digitally recorded information.

The system according to the invention is general but still permits individual management of different parties' information, thanks to the fact that different parties with different needs can be given access to different regions on the imaginary surface and can control how their own information is to be managed.

The system is also easy to use, as the user does not himself need to define in each situation how the recorded information is to be managed. This is controlled instead by the position content of the recorded information.

The look-up unit does not need to process the recorded information itself, but has the principal task of carrying out a reference service by referring an address to the user unit. This permits centralized management and distributed processing of digitally recorded information.

In an advantageous embodiment, the information recorded by the user unit is represented by a plurality of positions, of which only a first subset is sent to the look-up unit. All positions in the recorded information do not need to be sent to the look-up unit in order for this to be able to carry out the reference service, for which reason the first subset preferably consists of only one or a few positions. The information management can thus be carried out more quickly, as the traffic to the look-up unit is minimized.

According to a further preferred embodiment, the user unit is arranged to send, in response to the receipt of the address from the look-up unit, a second subset of the recorded information to the address. This second subset comprises suitably a sequence of positions on the imaginary surface, which positions create digital message information, such as interrelated lines. The address preferably identifies a recipient unit, such as a computer, a server unit, or mobile phone or a PDA, in which the second subset is processed and/or displayed. The address can thus be of different types depending upon application, such as an IP address, a fax address, a telephone number, an e-mail address or a Bluetooth® address.

According to a preferred embodiment, the user unit is arranged to initiate, upon recording a command field on the base, transmission of all or parts of the recorded information. The base is thus provided with a command field using which the user can cause the user unit to send the recorded information. From the user's point of view, the transmission is made to a recipient unit, about which the user does not need to have explicit knowledge. However, the transmission is carried out first to the look-up unit, which, on the basis of the position content of the received information, determines an address for the recipient unit in question and sends back the address to the user unit. Thereafter the user unit sends all or parts of the recorded information to the recipient unit in question. An advantage of this command field is that a user does not need to press keys or buttons on the user unit itself or on an associated computer to which the information is transmitted, but instead the user uses the command field on the base as a simple means of causing the user unit to send the information. Nor does the user need to direct where the information is to be sent, as this is given by the position content of the information.

The imaginary surface can consist of all the positions whose absolute coordinates a position-coding pattern has the capacity to code, each position being defined by at least two coordinates. If there are several imaginary surfaces, a third coordinate can be used to define which imaginary surface is involved.

The information is recorded suitably on a base by means of at least one subset of the position-coding pattern, which subset is reproduced on this base. The position-coding pattern thus codes positions both locally on the base and globally on the imaginary surface. When the user unit is moved across the base provided with the position-coding pattern, a sequence of positions is recorded which thus creates a digital graph or track of the movement of the user unit on the base, that is within one or more regions on the imaginary surface.

Figuratively, this can be regarded as if one or more subsets or partial areas of a large position-coding pattern are “cut out” and placed on the base. Each partial area codes at least one position on the imaginary surface. By reading off the position-coding pattern in a partial area, the coordinates can be determined for one or more positions within the partial area and using these coordinates it is thus possible to determine the region affiliation and consequently the address to which the recorded address is to be sent.

It is preferable for the recorded information to contain message information which is written on a message field on the base using the user unit. This message field contains a first subset of the position-coding pattern which codes several positions within a first region on the imaginary surface, which first region is dedicated to recording message information in the form of a sequence of positions on the imaginary surface. The recorded message information can be in the form of handwritten notes or drawings, that is it can be graphical input.

The user unit which detects the position-coding pattern and the command field can be one and the same user unit which uses one and the same sensor. It can alternatively use two different sensors or consist of two physically separate units, one of which detects the position-coding pattern and the other the command field. However, the use of one and the same user unit should be more user-friendly. It is also preferable for the command field to be provided with a position-coding pattern, so that the message information and the command information can be recorded according to the same principle, which simplifies the design of the user unit and its handling. More specifically, the command field is preferably provided with a second subset of the position-coding pattern which codes at least one position within a second region on the imaginary surface, which second region is dedicated to initiating transmission of all or parts of the recorded information, suitably to the look-up unit and then on to the address which the user unit receives from the look-up unit.

The user unit can be a digital pen which can be used to write ordinary pigment-based information on a sheet of paper, which information is recorded digitally in the user unit at the same time. The user unit can also be some other hand-held electronic device, by means of which information can be recorded, for example a PDA with a pressure-sensitive screen. In this example, the information can be recorded by a user writing information on the screen and by position coordinates being generated on the basis of where on the screen pressure is applied.

The system can advantageously contain a plurality of user units all of which communicate with the same look-up unit.

The user unit has suitably a unique user identity, the user unit being arranged, in connection with the transmission of all or parts of the recorded information, to send the user identity to the look-up unit. The unique identity can, for example, be a serial number or some form of code which has been stored in the user unit specifically for this purpose. The user identity can be used by the look-up unit to determine to which user unit the address is to be sent.

In one embodiment, the look-up unit can be arranged to attach to the address a program file which is associated with the region in question. The program file is executed by the user unit. In this way, a region owner can cause message information which is recorded within his region to be processed in a particular way before it is sent to the address that the user unit receives from the look-up unit.

Each user unit has advantageously a pen point. When the user writes with the user unit, both a paper copy and an electronic description of which was written are obtained. Alternatively, however, the user unit can be used exclusively for recording information electronically.

The functions described above which are carried out by the look-up unit are preferably achieved by means of suitable software in a server unit which is part of a computer network.

According to a preferred embodiment, the second subset of the position-coding pattern is placed on a plurality of bases and creates a universal command field for the transmission of information to the look-up unit. Such universal command fields have the advantage that the decoding in the user unit is simple, as this only needs to recognize one or a few command fields in order to be able to initiate the transmission of information. The use of universal command fields is also more economical with the available imaginary surface.

According to another preferred embodiment, the first and the second regions are incorporated in a primary main region which is dedicated to transmission of information to the look-up unit. The main region contains suitably a plurality of identical standard regions, the first and the second region being incorporated in such a standard region. The main region is thus hierarchically structured, which has the advantage that the user unit can store detailed particulars about the main region efficiently, for example in the form of an algorithm-based database. As a result, the user unit can independently and simply identify and initiate/execute operations which are allocated to different regions within the main region, which in turn means that the result of these operations can be shown to the user on a display and that the user has the opportunity to confirm that the recorded information is correct before further measures are taken. The use of standard pages also makes it easier for the user unit to determine what is to be sent to the address identified by the look-up unit, as the user unit can send the information which has been recorded on one or more standard regions within the main region.

According to a second aspect of the invention, this relates to a look-up unit, which is arranged to be incorporated in a system for information management, the lookup unit having a memory which stores particulars about a plurality of regions, each of which corresponds to an area on an imaginary surface and is allocated an address, and the look-up unit being arranged, in response to the receipt of at least one position from a user unit, to determine to which region said at least one position belongs, and to send the address which is allocated to the identified region to the user unit.

The advantages of the look-up unit are apparent from the discussion of the system.

According to a third aspect of the invention, this relates to a user unit for electronic recording of information which comprises at least one position, the user unit being arranged to send said at least one position to a look-up unit, and, in response to the receipt of an address from the look-up unit, to send all or parts of the recorded information to said address.

This user unit utilizes the same principle as described above, namely the position information is used both to record information and to control where the information is to be sent.

According to a fourth aspect of the invention, this relates to a computer program comprising instructions which cause a processor, in response to the receipt of at least one position from a user unit, to determine to which of a plurality of regions, each of which corresponds to an area on an imaginary surface, said at least one position belongs, and to send to the user unit an address which is allocated to the identified region.

The computer program is used advantageously to realize the function of the look-up unit.

According to a fifth aspect of the invention, this relates to a method for management of information which comprises at least one position and which is recorded electronically by a user by means of a user unit, the method comprising the following steps: the user unit sends said at least one position to a look-up unit; on the basis of said at least one position, the look-up unit identifies one of a plurality of regions on an imaginary surface, about which the look-up unit stores particulars and which is defined by a large number of positions; on the basis of the identified region, the look-up unit determines an address; and the look-up unit sends the determined address to the user unit.

The advantages of the method are apparent from the discussion of the system.

### BRIEF DESCRIPTION OF THE DRAWINGS

This invention and its characteristics, objects and advantages will be described in greater detail in the following with reference to the accompanying drawings, which for the purpose of exemplification show currently preferred embodiments.

FIG. 1 is a schematic view of a system according to an embodiment of the present invention.

FIG. 2 is a schematic diagram that shows an example of a data structure in a memory in a look-up unit incorporated in the system.

FIG. 3 is a schematic internal view of a user unit.

FIG. 4 is a schematic diagram that shows in greater detail than FIG. 1 an imaginary surface with main regions which are dedicated to different purposes.

FIGS. 5a-b are schematic diagrams which show an example of the generation of a “send” command.

FIG. 6 is a schematic diagram that shows examples of a first embodiment with exchange of information between units in the system.

FIG. 7 is a schematic diagram that shows in greater detail subregions in a hierarchically organized main region on the imaginary surface in FIG. 4.

FIG. 8 is a schematic diagram that shows an example of the layout of the subregions at the lowest level of the main region in FIG. 7.

FIG. 9 is a schematic diagram that shows examples of a second embodiment with exchange of information between units in the system.

FIG. 10 is a schematic diagram that shows a product which is provided with a position-coding pattern according to a preferred embodiment.

FIG. 11 is a schematic diagram that shows how the marks can be designed and positioned in a preferred embodiment of the position-coding pattern.

FIG. 12 is a schematic diagram that shows examples of 4*4 symbols which are used to code a position.

### DESCRIPTION OF PREFERRED EMBODIMENTS

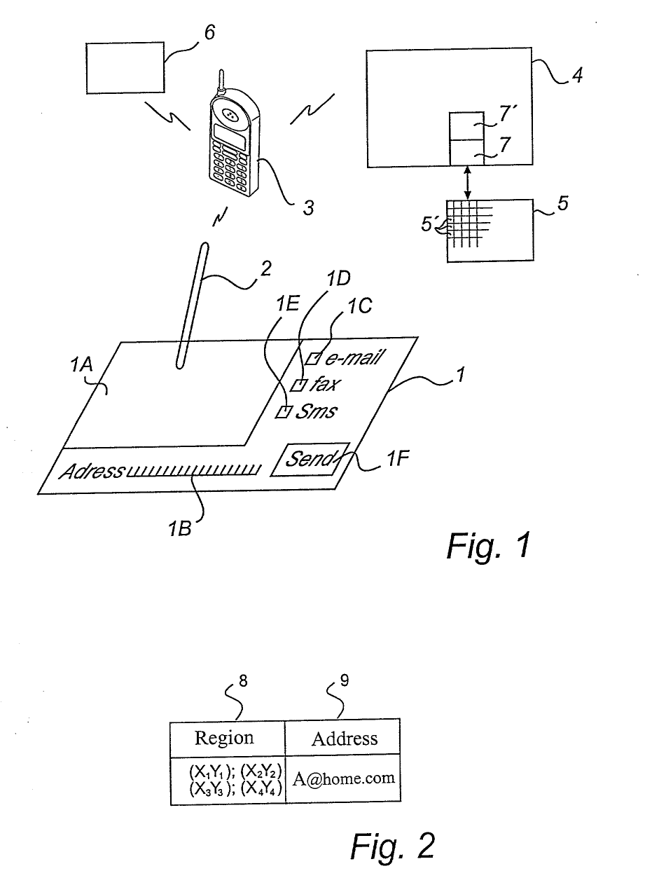

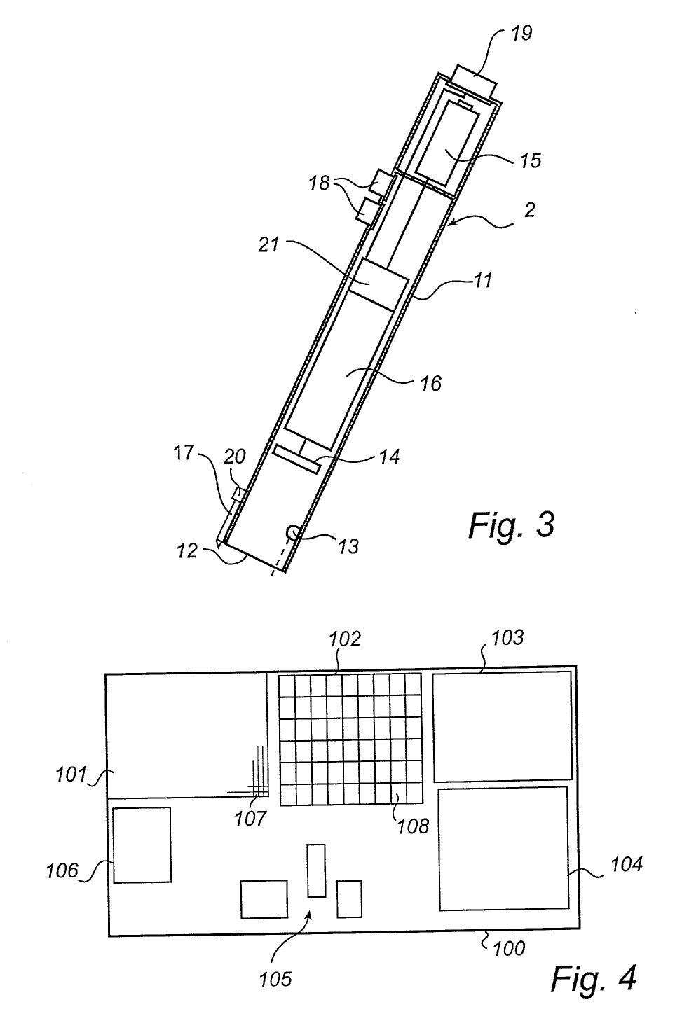

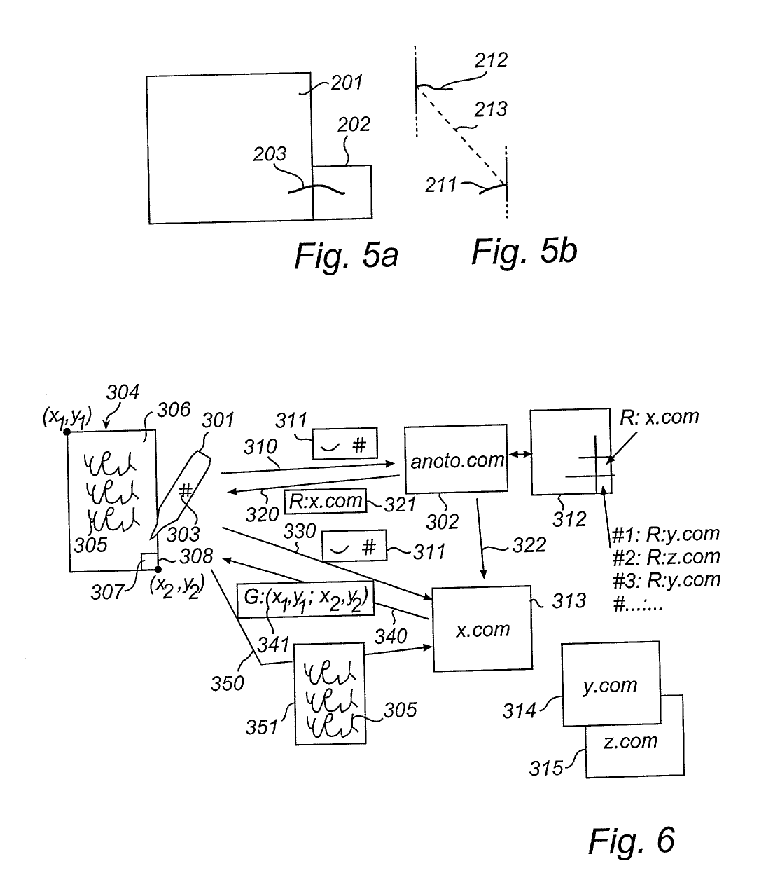

By way of introduction, the overall construction of an information management system according to the invention and its function will be described, with reference to FIGS. 1 and 2. Thereafter components which are part of the system will be described, among other things with reference to FIG. 3, followed by a more detailed example of the layout of the imaginary surface incorporated in the system, with reference to FIG. 4. Finally, examples are given of different forms of exchange of information in the system, with reference to FIGS. 5-9.

General Structure and Function

FIG. 1 shows an example of how a system according to the invention can be constructed. The system comprises principally a plurality of products or bases, a plurality of user units, a plurality of network connection units and one or more external look-up units. For the sake of clarity, however, only one base 1, one user unit 2, one network connection unit 3 and one look-up unit 4 are shown in FIG. 1.

The system permits structured management of information which a user records on a product 1 using a user unit 2. The product 1 is provided with a position-coding pattern (not shown) which is interpreted by the user unit 2 as absolute coordinates on the surface of the product 1. The position-coding pattern is such that it codes absolute positions on a total surface 5 which is much larger than the surface of the product 1. The total surface 5 consists of or is made up by all the positions whose absolute coordinates the position-coding pattern is capable of coding. The total surface 5 is divided into coordinate areas or regions 5′, which are each allocated an address. The address can, for example, be an IP address of a computer in a computer network, which is shown schematically in FIG. 1 as the recipient unit 6.

FIG. 2 shows an example of a data structure in a memory 7 in the look-up unit 4. In this case the data structure is a table. In a first column 8 in the table the regions on the imaginary surface 5 are defined by means of the coordinates (x1,y1; x2,y2; x3,y3; x4,y4) for the corners of the regions 5′. In a second column 9, an address is defined, to which information which is associated with a particular region is to be sent. For the sake of clarity, the structure in FIG. 2 only contains particulars about one region on the total surface. The structure normally contains particulars about a large number of regions with associated addresses.

When a user moves the user unit 2 across the surface of the product 1, information is recorded in the form of a digital graph containing one or more pairs of absolute coordinates. The digital graph also contains message information, such as text, symbols or figures. All or parts of this recorded information is communicated, automatically or upon command, via the network connection unit 3 to the look-up unit 4. The look-up unit 4, whose memory 7 contains particulars about the total surface 5 and its subdivision, contains software which causes its processor 7′ to identify to which region 5′ the received information belongs, based on the coordinate content of the received information. The address which is allocated to this region 5′ is sent via the network connection unit 3 back to the user unit 2, which sends the recorded information via the network connection unit 3 to the address obtained from the look-up unit 4, for example, to the recipient unit 6.

The recorded information can be sent in its entirety to the look-up unit 4, in which it can be processed and sent back to the user unit 2 together with the above-mentioned address. The processing in the look-up unit 4 can thereby be carried out dependent upon the region affiliation of the recorded information.

As an alternative, only one pair or a few pairs of coordinates of the recorded information are sent to the look-up unit 4, which returns the above-mentioned address to the user unit 2, which sends all or parts of the recorded information to the address obtained.

In addition to an address, a region can be allocated a program file in the look-up unit's 4 memory 7. When the look-up unit 4 determines that the received information contains coordinates within a region which is allocated such a program file, it also sends the program file to the user unit 2. The program file is executed in the user unit 2 for processing of the recorded information, whereupon the information thus processed is sent to the received address. Such a program file can, for example, format, compress or encrypt the recorded information before it is sent, or cause the user unit 2 to interact with the user via a display on the network connection unit 3.

A system as described above permits structured management of information. Different parties with different needs can have access to different parts of the total surface 5 and can control how their own information is to be managed. The system is general but also permits individual management of different parties' information.

The system is also easy to use, as the user does not himself need to define in each situation how the recorded information is to be managed. This is controlled instead by the coordinates and region affiliation of the recorded information. The user can work largely as he does with paper and pen, but still make use of all the possibilities of electronics, as the recorded information can be managed easily and unambiguously in the system according to the invention.

The Product

The product 1 can be any product which can be provided with coordinates so that these can be read off by the user unit 2. The coordinates can be given in explicit or in coded form. The coordinates are preferably arranged on a writing surface on the product 1, which can be of any material, such as paper, plastic, etc. The coordinates can also be integrated in or arranged upon a computer screen. In this way, a screen is achieved with the same function as a touch screen, but with the advantages that it is unaffected by the environment and that the screen can be bent. The coordinates can alternatively be displayed electronically on a computer screen or some other display screen.

In this example, however, the product 1 consists of a sheet of paper which is provided across its whole surface with a position-coding pattern which is shown very simplified and enlarged as a number of dots on the sheet of paper. The position-coding pattern on the product 1 constitutes a subset of a larger position-coding pattern.

The product 1 shown in FIG. 1 is divided into a plurality of different fields 1A-1F. In this example, the product 1 is intended for the transmission of electronic messages. The surface of the product has a writing field 1A for recording handwritten information, an ICR field 1B for recording handwritten information which, after character interpretation, forms address information, three service selection fields 1C-1E for recording the choice of transportation system (e-mail, fax or SMS), and a “send” field 1F. The function of this type of product will be apparent from the following description.

The Position-Coding Pattern

The position-coding pattern can be constructed in various ways, but has the general characteristic that if any subset of the pattern of a particular minimum size is recorded, then the position of this subset in the position-coding pattern and thus on the product can be determined unambiguously.

The position-coding pattern can be of the type which is shown in the above-mentioned U.S. Pat. No. 5,852,434, where each position is coded by a specific symbol.

It is, however, desirable for the position-coding pattern to be used to record information at a high resolution and in addition to be used in a system which permits varied processing of the information. Therefore the pattern should be designed in such a way that it can code a very large number of positions, given by absolute coordinates, at high resolution. In addition, the position-coding pattern should be coded graphically in such a way that it does not dominate or interfere with the visual impression of the surface of the product. The position-coding pattern should also be easy to detect, so that the coordinates can be determined with high reliability.

Therefore the position-coding pattern is advantageously of the type which is shown in the Published International Patent Application WO 00/73983 filed on May 26, 2000, or in the International Patent Application PCT/SE00/01895 filed on Oct. 2, 2000, both of which applications are assigned to the present Applicant. In these patterns each position is coded by a plurality of symbols, and each symbol contributes to the coding of several positions. The position-coding pattern is constructed of a small number of types of symbols.

An example is shown in WO 00/73983 where a larger dot represents a “lone” and a smaller dot represents a “zero”.

The currently most preferred pattern is shown in PCT/SE00/01895, where four different displacements of a dot in relation to a raster point code four different values. This pattern is constructed of extremely small dots with a diameter of approximately 0.072 mm and at a nominal spacing of approximately 0.3 mm. Any part of the pattern which contains 6×6 such dots defines a pair of absolute coordinates. Each pair of absolute coordinates is thus defined by an approximately 1.8 mm×1.8 mm subset of the position-coding pattern. By means of determination of the position of the 6×6 dots on the sensor in the user unit which is used to read off the pattern, an absolute position on the imaginary surface can be calculated by interpolation with a resolution of approximately 0.03 mm. A more complete description of the position-coding pattern according to PCT/SE00/01895 is given in the following Appendix.

This position-coding pattern is able to code a large number of absolute positions. As each position is coded by 6×6 dots, each of which can have one of four values, 4³⁶ positions can be coded, which with the above-mentioned nominal distance between the dots corresponds to a surface of 4.6 million km².

The position-coding pattern can be printed on any base which is capable of a resolution of approximately 600 dpi. The base can be any size and shape, depending upon its planned use. The pattern can be printed by standard offset printing technology. Ordinary black carbon-based printing ink or some other printing ink which absorbs infrared light can advantageously be used. This means that other inks, including black ink which is not carbon-based, can be used to superimpose other printing on the position-coding pattern without interfering with the reading off of this.

A surface which is provided with the above-mentioned pattern printed with a carbon-based black printing ink will be perceived by the eye as only a pale gray shading of the surface (1-3% density), which is user-friendly and esthetically pleasing.

Of course, fewer or more symbols can be used to define a position than as described above, and larger or smaller distances between the symbols can be used in the pattern. The examples are only given to show a currently preferred realization of the pattern.

The Look-up Unit

In this embodiment, the look-up unit 4 is a computer in a network of computers. It is constructed as a traditional server unit with one or more processors, memories of various kinds, peripherals and connections to other computers in the network, but it has new software in order to carry out the functions described here. It also has a memory 7 (see FIG. 1) in which particulars are stored about the imaginary surface 5.

As shown above, several user units 2 can be arranged to send information to the look-up unit 4 which is thus a central component in the system. Several such systems can, however, together form an even larger system.

The look-up unit 4 does not need to be incorporated in a global computer network, but can be incorporated in a local network and can be used to manage information, for example within a company.

The Imaqinary Surface

The position-coding pattern thus makes up a total surface 5 which is imaginary in as much as it is very large and is never present in its entirety on a base or a product. The imaginary surface 5 can be regarded as a virtual surface which is made up by all the positions which the position-coding pattern can code. The imaginary surface 5 can be said to be a surface in a coordinate system, which surface thus contains a large number of positions which are systematically arranged in two dimensions with a particular resolution. Each position can be defined by two coordinates. If there is more than one imaginary surface, more than two coordinates can be required to define a position.

As mentioned above, the imaginary surface 5 is divided into regions 5′. Each region 5′ can be dedicated to a particular type of information management, for different parties, different products, different operations, different types of information, etc. A detailed example of an imaginary surface is given after the description of the user unit below.

No single unit in the system needs to have knowledge of the whole of the imaginary surface 5, but particulars about the imaginary surface can be distributed over a number of different units. For the administration of the system it is, however, preferable for a central unit to have knowledge of which regions are already reserved and which regions are free. The central unit can be a passive part of the information management system and thus does not carry out any part of the actual management of information and therefore does not need to be connected to the other units in the information management system. In this case the look-up unit 4 in FIG. 1 contains a selection of particulars about all or a limited part of the imaginary surface 5.

Alternatively, the central unit can be an active part of the information management system. For example, the look-up unit 4 in FIG. 1 constitutes this central unit. There are detailed particulars in the look-up unit's 4 memory about the imaginary surface 5, such as particulars about the extent of the imaginary surface and about the position and extent of various regions which have been dedicated to different information management purposes or different commands which are to be carried out with regard to information which is managed in the system. However, information about the precise use of a particular region may be available only at the party that at the time has the sole right to use the region.

The user unit 2 has suitably at least limited knowledge of the imaginary surface, for reasons which are made apparent below.

The User Unit

FIG. 3 shows an example of a user unit, which in a preferred embodiment is used to record electronically graphical information which is created on a writing surface and to initiate/execute out commands or operations on this information.

The user unit comprises a casing 11 which is the same shape as a pen. A short side of the casing has an opening 12 and is intended to be held in contact with or a short distance from a base (not shown) provided with a position-coding pattern.

The user unit, below called a digital pen, contains essentially an optics part, an electronic circuitry part and a power supply.

The optics part forms a digital camera and comprises at least one infrared light-emitting diode 13 for illuminating the surface which is to be imaged and a light-sensitive area sensor 14, for example a CCD or CMOS sensor, for recording a two-dimensional image. The pen may also contain a lens system (not shown). The infrared light is absorbed by the symbols in the position-coding pattern and in this way makes them visible to the sensor 14. The sensor records advantageously at least 100 images per second.

The power supply for the pen is obtained from a battery 15 which is mounted in a separate compartment in the casing. Alternatively, however, the pen can be connected to an external power source.

The electronic circuitry part comprises a signal processor 16 for determining a position on the basis of the image recorded by the sensor 14 and more specifically a processor unit with a microprocessor which is programmed to record images from the sensor 14 and to determine in real time absolute coordinates for positions on the imaginary surface on the basis of the imaged subset of the position-coding pattern. In an alternative embodiment, the signal processor 16 is realized as an ASIC (Application Specific Integrated Circuit) or an FPGA (Field Programmable Gate Array).

The position determination is thus carried out by the signal processor 16 which thus must have software to enable it to locate and decode the symbols in an image and to enable it to determine positions from the codes thus obtained. A person skilled in the art would be able to design such software from the description in the above-mentioned Patent Applications WO 00/73983 and PCT/SE00/01895.

The signal processor 16 can also have limited information about the different regions on the imaginary surface and about what these are dedicated to. The signal processor 16 can, for example, advantageously contain particulars which make it possible for it to recognize that certain points or regions on the imaginary surface represent certain commands or operations which are to be initiated and/or implemented with regard to information which has been or will be recorded. Preferred commands which can be recognized by the pen are “store”, “send”, “to do”, “address” and other similar basic commands. The pen has advantageously an indicator (not shown), for example a light-emitting diode, a buzzer or a vibrator, which gives a signal when the pen detects a command. The signal serves to make the user aware than a command has been recorded. Of course these indicators can also be used to give an indication that the pen has recorded handwritten information.

The pen can advantageously also contain information which makes it possible for it to distinguish between, for example, information which is to be stored in the pen, information which is to be transferred to the user's personal computer, information which is to be sent to a fax number via a modem and information which is to be sent to a server unit at a predetermined IP address, for example the look-up unit 4 in FIG. 1.

More specifically, as described above, a region on the imaginary surface can be dedicated to information which is always to be sent to said IP address, which information is recorded by means of a subset of the position-coding pattern which corresponds to this region and is thus represented by coordinates for points which lie within the region. The signal processor 16 is suitably programmed to select one pair or a few pairs of coordinates from the recorded pairs of coordinates and to send this pair of coordinates to the look-up unit 4. Finally, the signal processor 16 is programmed to send all the recorded information, or selected parts thereof, to an address which it receives from the look-up unit 4 in response to the sending of the pair of coordinates.

The digital pen comprises in this embodiment a pen point 17, using which the user can carry out ordinary pigment-based writing on the surface provided with the position-coding pattern. The pen point 17 can be extended and retracted so that the user can control whether or not it is to be used. A button (not shown) for extending and retracting the pen point 17, in the same way as in an ordinary ball-point pen, can also function as an on/off button for the pen, so that the pen is activated when the pen point 17 is extended.

The digital pen can also comprise buttons 18 by which it is activated and controlled. It also has a transceiver 19 for short-distance wireless transmission, for example using infrared light or radio waves, of information to and from the pen. In the currently most preferred embodiment the transceiver 19 is a Bluetooth® transceiver.

The digital pen is also suitably provided with a pressure sensor 20 which measures the pressure on the pen point 17 when this is used. The signal processor 16 can comprise software which determines the angle between the pen point 17 and the base and also the rotation of the pen on the basis of the recorded images. Software for this purpose is described in Applicant's Swedish Patent Application No. 0000952-2. In a preferred embodiment, the signal processor 16 determines the following information on the basis of each recorded image: a pair of coordinates, the angle between the pen and the base, the rotation of the pen, the pressure on the base and in addition a time-stamp on the basis of the time of the recording of the image. Depending upon how the information management system is constructed, it can, however, be sufficient to record the pair of coordinates, possibly together with any of the other parameters.

The recorded pair of coordinates can be processed and stored in a compressed format. The signal processor 16 can, for example, be programmed to analyze a sequence of pairs of coordinates and convert these into a polygon train which constitutes a description of how the pen has been moved across the surface which is provided with the position-coding pattern. All the recorded data can be stored in a buffer memory 21 awaiting transmission to an external unit, for example the look-up unit 4 or the recipient unit 6 in FIG. 1. The digital pen can thus work in stand-alone mode, that is the pen sends the information when it has the opportunity, for example when it makes contact with the external unit, whereupon it retrieves recorded information from the buffer memory 21. It must also be pointed out that the signal processor 16 does not need to forward all the information to the external unit, but can be programmed to analyze the recorded coordinates and only to forward information which is represented by coordinates within a particular coordinate area. The information can also be forwarded immediately on-line.

The signal processor 16 can also have software for encrypting the information which is sent to the external units.

It is also desirable for only simpler, less time-consuming and memory-intensive processing of the recorded information and processing of security-sensitive information to be carried out in the pen. More complicated processing can be carried out in an external unit, such as in a local computer, with which the pen communicates and in which software is installed for processing information from the pen, and/or in the look-up unit 4 which can contain very powerful software for, among other things, character recognition (OCR), a larger amount of memory, for example for database particulars, and faster signal processors for more advanced processing of the information. The processing can also be carried out in the recipient unit 6.

Such distribution of the information processing makes it possible to manufacture pens at a relatively low cost. In addition, new applications can be added to the information management system without the existing pens needing to be upgraded. Alternatively, the user can update his pen at regular intervals so that it receives particulars about new dedicated regions and about how information which is related to these regions is to be managed and also new functionality.

The above example is only given to show a currently preferred realization of the digital pen. In an alternative embodiment, the pen operates only as an image gene-rator, that is the images recorded by the sensor 14 are transmitted to an external unit, for example a local computer, which processes the images to determine coordinates as above, and which communicates if necessary with other external units, such as the look-up unit 4 and the recipient unit 6 in FIG. 1.

In the embodiment above, the pattern is optically readable and the sensor 14 is thus optical. The pattern can, however, be based on a parameter other than an optical parameter. In such a case, the sensor must of course be of a type which can read the parameter concerned. Examples of such parameters are chemical, acoustic or electromagnetic marks. Capacitive or inductive marks can also be used. However, it is preferable for the pattern to be optically readable as it is then relatively simple to apply it onto different products and in particular onto paper.

Communication Between the User Unit and External Units

Certain operations can be carried out in their entirety by the user unit 2 itself, for example storing of notes in the user unit and input of particulars in a user program in the user unit. These operations can always be carried out by the user unit 2 in stand-alone mode.

Other operations require communication with the outside world. These operations can be commenced in stand-alone mode, but are not completed until the user unit 2 is connected to the outside world.

The user unit 2 is, as shown above, arranged to transmit recorded information to the look-up unit 4 and thereafter to the recipient unit 6. In FIG. 1 the information is transmitted by wireless means to the network connection unit 3, which in turn transmits the information to the look-up unit 4 or the recipient unit 6. Instead of a mobile phone the network connection unit 3 can be a PDA, a computer or some other suitable unit which has an interface to a computer network, for example the Internet or a local company network. The network connection unit 3 can, alternatively, constitute an integrated part of the user unit 2.

As shown by the above description of the user unit, the communication between the user unit 2 and the network connection unit 3, which are normally located fairly close to each other, can be carried out, for example, via infrared radiation or radio waves, for example according to the Bluetooth® technology, or some other technology for the transfer of information across short distances.

Alternatively, the transmission can be via cables. For example, the user unit 2 can be connected via a cable to the network connection unit 3. Alternatively, the network connection unit 3 can be designed as a docking unit (not shown) which can be connected via cables to a communication network, such as a telephone network or a computer network. Such a docking unit can advantageously be designed as a pen stand. When the user unit 2 is placed in the docking unit, the user unit 2 is caused, automatically or upon command, to communicate with the outside world, such as the look-up unit 4 and the recipient unit 6. The docking unit can also be designed to charge the battery 15 (FIG. 2) in the user unit 2. According to another alternative, the docking unit is designed to establish a wireless connection with the outside world.

Detailed Example of Imaginary Surface

FIG. 4 shows schematically an imaginary surface 100 which constitutes or is made up by all the positions whose absolute coordinates can be coded by a position-coding pattern. A number of different main regions 101-106 are defined on the imaginary surface 100. These main regions are in general divided into subregions, which can be divided into further subregions, etc.

In the discussion of the embodiment shown in FIG. 4, it is assumed that the imaginary surface 100 consists of pairs of x- and y-coordinates of binary type, that is consisting of ones and zeros, where the pairs of coordinates have a length of 36 bits for both the x-coordinate and the y-coordinate. The position-coding pattern thus codes pairs of coordinates which make up an imaginary surface with 4³⁶ points or positions.

In this example, a “send” region 101 is dedicated to be used for generation of “send” commands from the user unit. The “send” region can, for example, be defined as all pairs of coordinates whose x-coordinate starts with 0001 and whose y-coordinate starts with 0001. As a result, for example, the four first bits in a pair of coordinates indicate its affiliation to a main region. With a division according to this example, 256 main regions are obtained.

In the example concerned, the four first bits indicate the main region affiliation, and a particular number of the last bits indicates the size of the subregions in the main region. In the “send” region 101, the size of the subregions 107 is the minimum, a so-called atom, consisting of 64*64 positions or corresponding to the six last bits. With a distance of 0.3 mm between the dots in the position-coding pattern, this corresponds to a pattern surface of approximately 20*20 mm². The other 26 bits (36−4−6) address the different subregions 107 (corresponding to a “send” box) in the “send” region 101. The total number of subregions 107 is then 4²⁶, that is over 4500 billion (4,503,599,627,370,496). Each subregion 107 (“send” box) can thus be identified by a number which consists of the 5th to the 30th bit of the x- and y-coordinates. The four first bits in each recorded pair of coordinates thus indicates in which main region the user unit is situated, the following 26 bits identify a subregion (for example, a particular “send” box) within the main region, and the six last bits indicate where in the subregion the user unit is situated.

These “send” boxes suitably belong to different recipients in a network which is connected to an information management system according to this invention. Information about such affiliation is stored in the information management system.

The second main region 102 is dedicated to notepad information and also comprises a large number of subregions 108 (corresponding to writing fields). Information about the position of these subregions 108 is preferably stored in a computer with which one or more user units communicate, or in the user units themselves. The position of the subregions 108 is predetermined so that all users of the system know in advance that notes made in these subregions 108 belong to the main region 102 which is dedicated to notepads.

For the main region 102 it is desirable that each subregion 108 (writing field) is larger than an A4 page, for example approximately 1 m² in size, corresponding to approximately 12 bits, to provide for essentially all formats of notepads. The number of subregions 108 (writing fields) in the main region 102 for the notepads is thus equal to 4²⁰, that is approximately 1 billion (1,099,511,627,776).

The third main region 103 is dedicated to recording handwritten information and to sending an address query to a look-up unit, such as the look-up unit 4 in FIG. 1.

Exchange of Information in the System

Where required, the user unit is to be caused to transmit at least part of the recorded information to the look-up unit for the purpose of obtaining an address of a recipient unit. This can be achieved by the information being recorded within a main region or subregion which is dedicated to initiating sending of an address query from the user unit to the look-up unit. Of course the user unit must know the position of this main region or subregion on the imaginary surface.

Below are given examples of two alternative embodiments of the exchange of information in a system according to the invention. In the embodiments different parts of the imaginary surface 100 illustrated in FIG. 4 are used.

Embodiment 1

According to a first alternative, one or more “send” boxes in the main region 101 in FIG. 4 are dedicated to initiating an address query to the look-up unit. If the user unit decodes a position within such a “send” box dedicated to address queries, an address query is thus sent to the look-up unit. Information can, for example, be recorded on a writing field in the main region 102. In the look-up unit the writing field, or a primary region containing the writing field, is allocated an address of a recipient unit. Alternatively, the “send” box, or a primary region containing the “send” box, can be allocated such an address.

The advantage of using such a universal “send” box intended for address queries is that this can be represented by the same subset of the position-coding pattern each time it is used, irrespective of whether it is, for example, on a note sheet or on an e-mail form. Another advantage is that the decoding in the user unit is simple, as this only needs to recognize that it is a “send” box that has been ticked, whereupon the user unit is to initiate an address query.

In the following, with reference to FIGS. 5a-b, an example is given of how different regions on the imaginary surface can be associated with each other. FIG. 5a shows a first partial area 201, which can be a subset of any of the main regions 101-106 in FIG. 41 adjoining a “send” box 202 from a “send” region, for example the “send” region 101 in FIG. 4. A pen stroke 203, which can be physically marked on a product provided with a position-coding pattern, has been generated by means of a user unit. The stroke or the track 203 has an extent which includes the position-coding pattern from both the partial areas 201 and 202, that is the stroke 203 extends across the boundary between the partial areas 201, 202.

As the partial areas 201, 202 belong to different regions which are physically separated on the imaginary surface 100 (FIG. 4), the pen stroke 203 crossing the boundary can be regarded as two separate strokes 211, 212, as shown in FIG. 5b. The distance between the first stroke 211 and the second stroke 212 is illustrated here by a broken line 213 (hyperline) which shows a discontinuity of the sequence of pairs of coordinates which are recorded when the mark is made across the boundary between the two partial areas. This detection of discontinuity can advantageously be used by the software in the user unit, or an associated computer, to order or commence transmission of particular information to the lookup unit.

FIG. 6 shows an example of an exchange of information based on the alternative described above with universal “send” boxes. FIG. 6 shows communicating units, such as a user unit 301 and a look-up unit 302, and also information and signals which are communicated between the units in the system.

Each user unit 301 has an identity 303, which below is called the pen ID. The user unit 301 has been used to generate an amount of message information 305 within a first field 306 on a product 304 with a position-coding pattern (not shown). The generated amount of information 305 has been stored in the user unit 301. After the user unit 301 has been used to create a “send” stroke 307 which crosses a boundary between the first field 306 and a “send” box 308, a first transmission step 310 is carried out in which the “send” stroke 307 is transmitted together with the pen ID 303 in a first information packet 311. The transmission is carried out to the look-up unit 302, which receives and analyses the information packet 311. The transmitted “send” stroke may contain only the 26 qualification bits for the “send” box 308, that is the bits which define its affiliation. The first four bits are after all self-evident, as these have been used by the user unit 301 to identify that the information packet 311 is to be sent to the look-up unit 302. The six last bits are in this case redundant, as it is of no significance where in the “send” box 308 the recording has been carried out.

The look-up unit 302 contains a database 312 with particulars about the imaginary surface 100 (FIG. 4). When the look-up unit 302 receives the first information packet 311, an address of a recipient unit 313 is retrieved from a database 312.

The recipient unit 313 is preferably one among many service provider units 313-315, typically servers, which use the look-up unit 302 as a link to user units 301.

In a first response step 320, the look-up unit 302 then sends an address notification packet 321 to the user unit 301 which is defined by the pen ID 303 in the information packet 311. This address notification packet 321 comprises the recipient address which was found in the database 312 and thus contains particulars which the user unit 301 can then use to make contact with the recipient unit 313. The packet 321 can contain further particulars, such as particulars about which parts of the imaginary surface 100 (FIG. 4) the user unit 301 can send to the recipient unit 313, that is which parts the recipient unit 313 has the right to access. The packet 321 can, as mentioned by way of introduction, also contain a program file. In addition, the look-up unit 302 can send a charging signal 322 to the recipient unit 313, which means that the service provider who has control over the recipient unit 313 is requested to pay for the use of the reference service which the look-up unit 302 has provided. Other ways of charging for the service can of course be used, or the service can be free of charge.

In a second transmission step 330, the user unit 301 then transmits the first information packet 311 to the recipient unit 313. In this step the important information is which region is associated with the “send” box 308 via the “send” stroke 307 (cf. the stroke segment 203 in FIG. 5). In certain cases, information about the “send” box 308 can also be of use in the second transmission step 330. For example, if a stroke segment of the “send” stroke 307 starts from a writing field in the main region 102 in FIG. 4, the first 24 bits of the coordinates for this stroke segment (corresponding to the stroke segment 203 in FIG. 5) can be transferred, of which the four first bits identify the main region and the 20 following bits identify the subregion concerned (the writing field) in the main region, while the 12 last bits can be omitted or set to zero.

A computer program is started in the recipient unit 313. Which program is started is dependent upon the received information, for example the coordinates for the “send” box or the writing field which are given by the “send” stroke 307. The computer program analyses the received information, after which, in a response step 340, it creates a data request 341 which is sent to the user unit 301 which is defined by the pen ID 303 in the information packet 311. This data request 341 can comprise instructions to the user unit 301 to create a data packet with the marks on the position-coding pattern of the product 304 which were made within a rectangle defined by the corner coordinates (x1,y1; x2,y2), which can correspond to the whole of the region which is identified by the “send” stroke 307 or specific parts thereof. In the case of a writing field in the main region 102 in FIG. 4, a request is sent concerning all the pairs of coordinates which are defined by the 24 first bits in the stroke segment starting from the writing field, that is all the notes which are made on a region the size of just over a square meter. The request can also cover only the message information which was recorded on this region since the last synchronization. In addition, the data request 341 can comprise an instruction to the user unit 301 to delete the sent notes from its memory.

The user unit 301 carries out this request, possibly after having checked whether the recipient unit 313 has the right to access the requested region (such information can have been obtained in the response message 321 from the look-up unit 302), and, in a final transmission step 350, transmits a second information packet 351 containing the amount of message information 305, that is tracks or a graph made within the area defined by the corner coordinates (x1,y1; x2,y2) on the imaginary surface. The information packet 351 can also contain further particulars, such as information previously stored in the user unit or a program file. As mentioned above, the user unit 301 can be programmed to pre-process part of the recorded information, for example by ICR interpretation. The recipient unit 313 then processes the content in the information packet 351.

It is possible to replace the steps 330, 340 and 350 by a single transmission step. This assumes that the user unit 301 obtains in some other way particulars about which amount of information, that is information recorded within a particular area on the imaginary surface, is to be sent to the recipient unit 313. Such particulars can, for example, be included in the data packet 321, or can be calculated by the user unit 301 if this contains sufficient particulars about the imaginary surface.

Embodiment 2

According to a second alternative, the information can be recorded within a subregion of the main region 103 in FIG. 4 dedicated to the address query. The subregion is allocated an address in the look-up unit. An address query is sent to the look-up unit either immediately, after a certain period of time or when the user unit decodes a position within a “send” box.

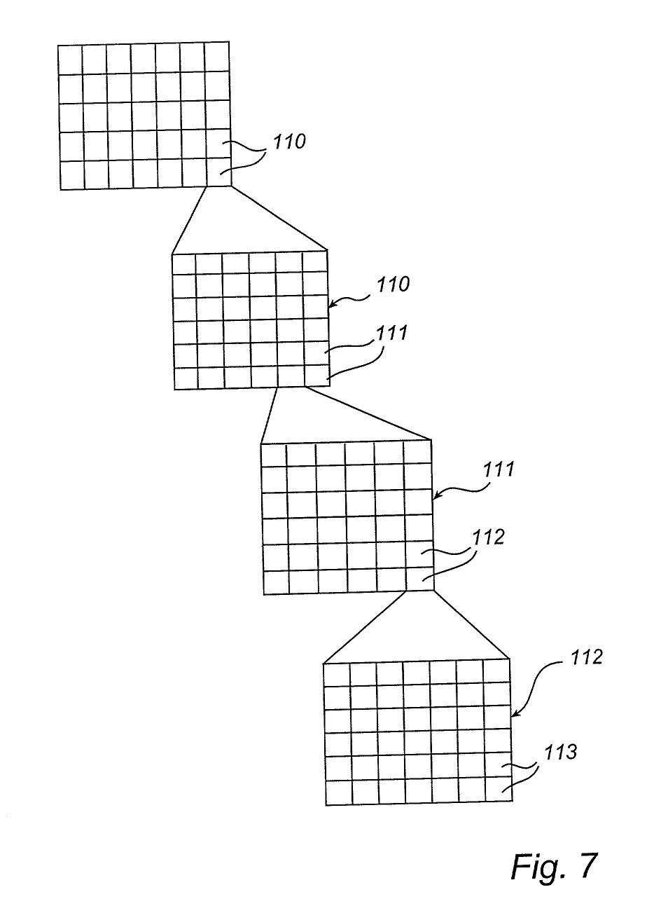

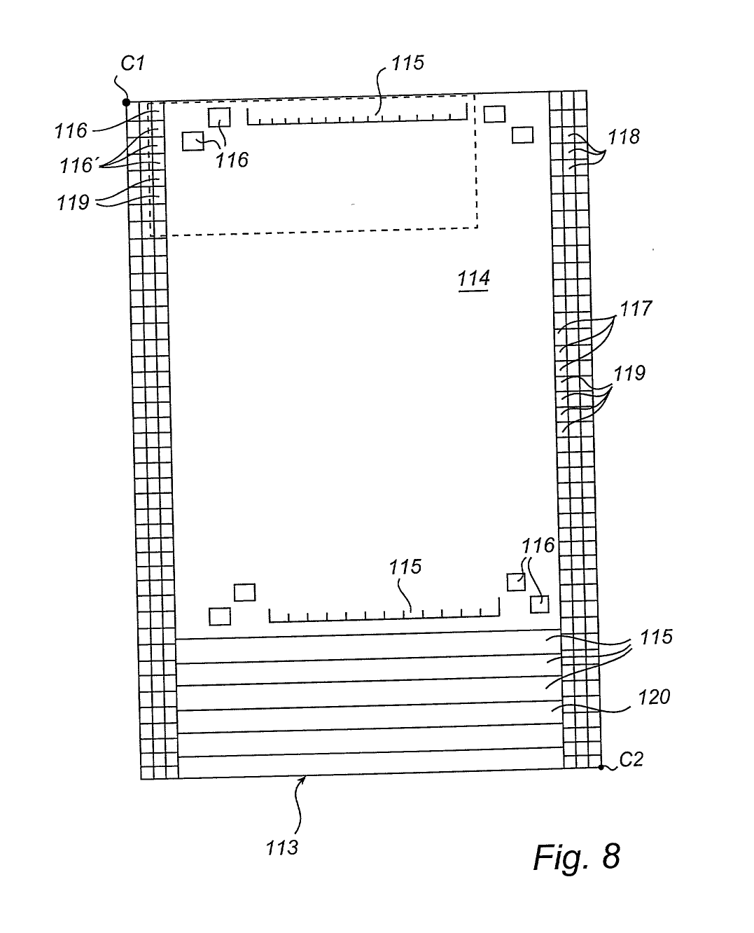

FIG. 7 shows a preferred structure of the main region 103 intended for address queries in FIG. 4. The main region 103 is divided into subregions 110-113 which contain basic elements in the form of pages 113. Each page 113 is a particular size and has a number of fields for predefined information management, as will be described in greater detail in connection with FIG. 8. For example, each main region 103 can be divided into a number of sections 110, each of which is divided into a number of shelves 111, each of which is divided into a number of books 112, each of which contains the above-mentioned pages 113. At a particular level within the subregions 110-112, all the pages 113 have an identical size and layout. For example, the sections 110 can contain different pages, while each section 110 contains shelves 111 and books 112 with identical pages 113. Alternatively, each section's 110 shelves 111 can contain different pages 113, while all books 112 within each shelf 111 have identical pages 113. Alternatively, the different books 112 can contain different pages 113, while the pages within each book 112 are identical. As a further alternative, the whole main region 103 can of course contain identical pages 113 in all the subregions 110-112.

The embodiment with a large number of identical pages permits the use of a simplified, preferably algorithm-based, database in the user unit's memory. The user unit stores a number of page templates, which define the size and layout of the pages of the different subregions 110-112 in the main region 103. Such a page template can be allocated to the highest subregion level which contains identical pages. With such a reduced database the user unit can independently and quickly calculate which information is to be sent to the recipient unit which was addressed by the look-up unit, for example all information which has been recorded on one or more pages. Suitably each section, shelf, book and page has an identifying designation, for example a number. A particular subregion, for example a page, can thus easily be addressed by giving a sequence of numbers, as follows:

section.shelf.book.page. For example, 35.100.4.0 can be interpreted as all the pages in book number 4 on shelf number 100 in section number 35. In addition, the different fields on each page can be addressed in a corresponding way: section.shelf.book.page.field.

Each section 110 can be dedicated to a particular type of information management, for example advertisements, communication, etc. Within each section one or more shelves, books or pages can be allocated to an owner. For example, an advertiser can lease a book with 512 A4 pages.

It should be stressed that the above is only an example and that the main region 103 can be divided into any number of subregion levels.

As mentioned above, each section 110, shelf 111, book 112, page 113 or field can be allocated particular properties. In addition to the above-mentioned layout of the pages, these properties can, for example, indicate how long the user unit is to store information which has been recorded without having been sent to an external unit, for example the look-up unit 4 or the recipient unit 6 in FIG. 1. Other properties can be that all recorded information is to be character interpreted (ICR), that all recorded information is to be sent directly, that is without the recording of a “send” box.

Each page 113 is coded by a subset of the position-coding pattern, which subset is intended to be applied onto the surface of the proposed product. This subset can be applied either continuously or discontinuously on the surface of the product, as will be explained in greater detail with reference to FIG. 8 which shows an example of the layout of a page 113 on the imaginary surface.

The page 113 in FIG. 7 is rectangular, and can thus be identified by the coordinates for two opposite corner points, C1, C2. The page 113 contains a number of fields 114-120 with completely or partially predetermined function.

A central writing field 114 is dedicated to recording of graphical information. ICR fields 115 are dedicated to character interpretation of the information recorded therein, of which one or more ICR fields can be predefined to concern address information, for example an e-mail address, a fax number or a street address, or can be dedicated to decoding only numbers or only letters. “Send” boxes 116 are dedicated to initiating sending of recorded information, of which certain “send” boxes can have predefined properties, for example initiating the sending of an e-mail message, a fax message or an SMS message. If a general “send” box 116 is used, this can instead be allocated service selection fields 116′, which indicate the different “transport systems” that can be used, for example e-mail, fax or SMS. Local command fields 117 are dedicated to initiating operations in the user unit's memory, for example to deleting all previously recorded information on the page in question from the user unit's memory, to compressing existing information in the user unit's memory, to inserting a bookmark in order to make it possible to the recreate the sequence of coordinates which had been recorded in the writing field when the bookmark was recorded, or to showing information recorded thus far on the page in question on a display, for example on a mobile phone or a local computer. Property fields 118 are dedicated to initiating sending of particulars stored in the user unit to an external unit. Such a property field 118 can, for example, initiate sending of the user's credit card number, postal address, e-mail address, etc. General command fields 119 are dedicated to initiating operations which are common to many different applications, for example, that the information which is to be sent is to be encrypted or given a particular priority, or that the information recorded in the writing field 114 is to be given certain visual properties, for example regarding color, line thickness or line type, which is reproduced when the information recorded in the writing field 114 is displayed, for example on a display on a computer or a mobile phone. A signature field 120 is dedicated to recording pairs of coordinates, the angle between the user unit and the base, the rotation of the user unit and the pressure on the base.

In the example above, the page 113 thus contains a plurality of message fields, such as writing fields 114, ICR fields 115 and signature fields 120, a plurality of command fields, such as “send” boxes 116, local command fields 117, property fields 118 and general command fields 119, and a plurality of selection fields 116′, for example for choice of service.

The user unit can, as mentioned above, store particulars about the page 113 in the form of an algorithmbased page template. More specifically, the different fields 114-120 can be identified as one or more positions on the page 113. For example, each “send” box can have a particular extent and can be located in a particular position on each page 113. Similarly, each ICR field can have a particular extent and a particular position on each page 113.

An advantage of the type of hierarchical structure described above is that the user unit can independently and simply identify and initiate the operations which are indicated by the above fields 114-120. Thus the result of these operations can be shown to the user on a display, for example on a mobile phone, a computer or on or associated with the user unit itself. The user has thus the opportunity to confirm that the result is correct before the recorded information is managed further in the system.

The owner of a particular page, book or shelf has the opportunity to design a product surface with a position-coding pattern, based on a page of the above-mentioned type. This can be carried out in two different ways.

The product surface can be constructed of a position-coding pattern which has a discontinuous layout. This can be regarded as if all or parts of the different fields 114-120 on the above page 113 are “cut out” and arranged into a required appearance. The actual location of the fields on the product surface is thus not related to the position of the fields on the imaginary surface, as different subsets of the position-coding pattern on the surface of the product are taken from different parts of the imaginary surface.

Such a discontinuous layout makes possible any placing and dimensioning of different fields on the surface of the product, as position-coding patterns which code parts of a “send” box, a writing field, etc, can be located anywhere on the surface of the product.

The surface of the product can alternatively be constructed of a position-coding pattern which has a continuous layout. This can be regarded as if a part of the above page is “cut out” and creates a finished layout, so that the whole surface of the product is provided with a position-coding pattern which codes coordinates for a coherent coordinate area on the imaginary surface. Such a layout for a form for sending any graphical information is indicated in FIG. 8 by broken lines.

The continuous position-coding pattern can be preferable in certain situations. The discontinuous layout of the position-coding pattern often requires the boundary between adjacent fields on the surface of the product to have no position-coding pattern for a certain distance, typically approximately 1 mm, so that the subsets which code coordinates on each side of the boundary can be detected unambiguously. Such boundary areas without position-coding pattern can be undesirable, particularly when the surface of the product is small. In these cases, a continuous layout of the position-coding pattern can be preferable.

It must also be pointed out that when designing the surface of the product, regardless of whether the pattern layout is continuous or discontinuous, the owner can have the opportunity to define in detail what the properties of each field are to be.

With both continuous and discontinuous layouts of the position-coding pattern, the advantage is obtained that the information which is to be sent to the recipient unit 6 in FIG. 1 is defined by the corner points C1, C2 for the page concerned. The user unit can thus, automatically or upon command, send to the recipient unit all the information which has been recorded within the corner points C1, C2 on the imaginary surface.

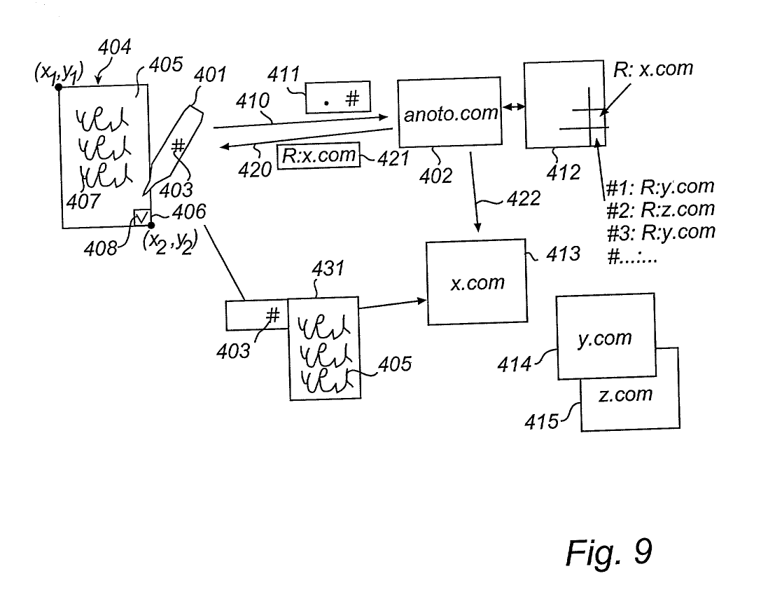

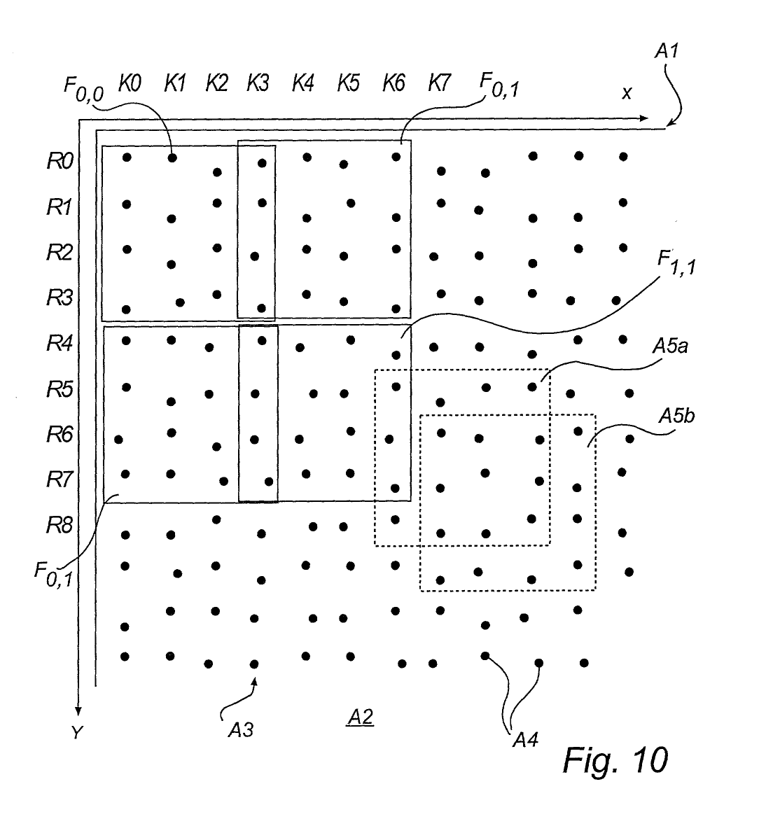

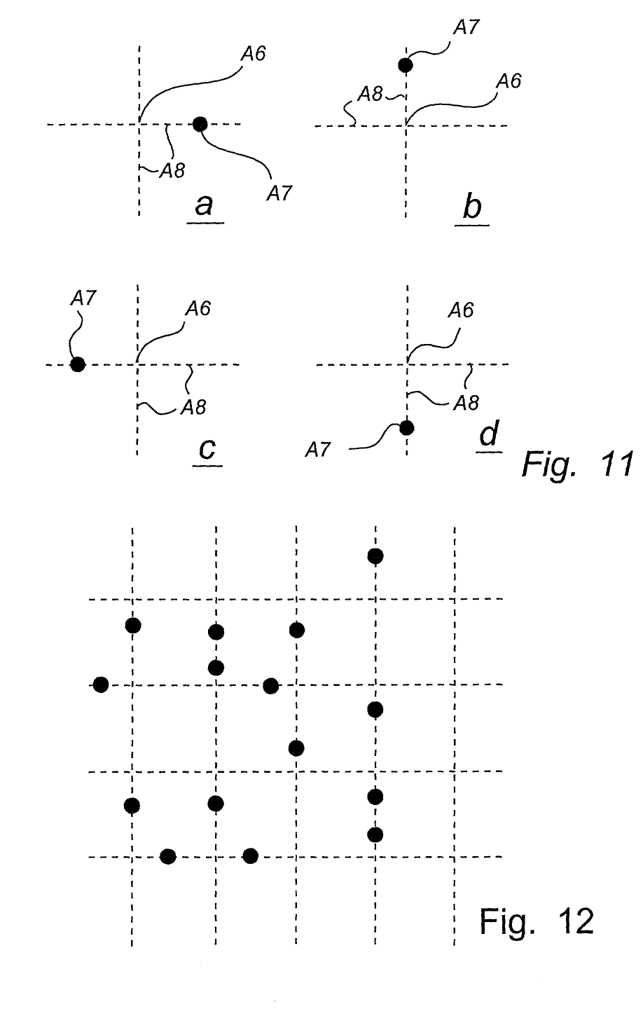

FIG. 9 shows an example of an exchange of information based on the alternative described above with a hierarchically organized main region. FIG. 9 shows communicating units, such as a user unit 401 and a look-up unit 402, and also information and signals which are exchanged between the units in the system.

Each user unit 401 has an identity 403, which is called below the pen ID. A product 404 is provided with a position-coding pattern (not shown) and has a writing field 405 and a “send” box 406. The position-coding pattern in the writing field 405 and the “send” box 406 codes positions within the main region 103 in FIG. 1 intended for address queries, more specifically within one and the same page, for example page 113 in FIG. 8. The user unit 401 has been used to generate an amount of message information 407 in the writing field 405. The generated amount of information 407 has been stored in the user unit 401. After the user unit 401 has been used to create a mark 408 in the “send” box 406, a first transmission step 410 is carried out in which one or more of the recorded information's pairs of coordinates, for example a pair of coordinates for the mark 408 or for the amount of information 407, are transmitted together with the pen ID 403 in a first information packet 411. In order to make the system less sensitive to interference, a larger number of recorded pairs of coordinates can be included in the information packet 411. The transmission is carried out to the look-up unit 402, which receives and analyses the information packet 411.

The look-up unit 402 contains a database 412 with particulars about the imaginary surface. When the look-up unit 402 receives the first information packet 411, an address is retrieved for a recipient unit 413 from the database 412. The recipient unit 413 is preferably one among many service provider units 413-415, typically servers, which use the look-up unit 402 as a link to user units 401.

In a response step 420, the look-up unit 402 then sends an address notification packet 421 to the user unit 401 which is defined by the pen ID in the information packet 411. This address notification packet 421 comprises the recipient address which was found in the database 412 and thus contains particulars which the user unit 401 can then use to make contact with the recipient unit 413. The packet 421 can contain further particulars, such as particulars about which parts of the imaginary surface the user unit 401 can send to the recipient unit 413, that is which parts the recipient unit 413 has the right to access. The packet 421 can, as mentioned by way of introduction, also contain a program file. In addition, the look-up unit 402 can send a billing signal 422 to the recipient unit 413, which means that the service provider who has control over the recipient unit 413 is requested to pay for the use of the notification service which the look-up unit 402 has provided. Other ways of charging for the service can of course be used, or the service can be free of charge.

In a second transmission step 430, the user unit 401 transmits a second information packet 431 which contains the amount of message information 407, that is the tracks or the graph recorded in one or more fields on the page on the imaginary surface defined by the corner coordinates (x1,y1; x2,y2), possibly after having first checked whether the recipient unit 413 has the right to access the page in question. The information packet 431 can also contain pen ID for identifying the user unit 401 and additional particulars, such as information previously stored in the user unit, or a program file. As mentioned above, the user unit 401 can be programmed to preprocess part of the recorded information, for example by ICR interpretation. The recipient unit 413 then processes the content in the information packet 431.

Applications

The technique described here for information management can be used in a large number of applications. A selection is given below, which is in no way intended to be complete.

For example, the recipient unit can be a computer or server unit which handles electronic messages, such as e-mail, particularly graphical e-mails, fax messages and SMS.

The recipient unit can alternatively be a computer or server unit which offers publication of handwritten information, for example on a webpage on the Internet, or storage of handwritten information.

As a further alternative, the recipient unit can be a computer or server unit which administers the ordering of goods or services from forms, advertisements, etc.

The address which is obtained from the look-up unit can alternatively refer to a local unit, such as computer, PDA, mobile phone, fax machine, etc. In this case, the user unit can, via its network connection unit or directly via its transceiver, send all or parts of the recorded information to the local unit, which is identified by, for example, an IP address or a Bluetooth® address.

The address from the look-up unit can also be an e-mail address, a fax number, etc, to which the user unit sends all or parts of the recorded information via the network connection unit or its transceiver.

Alternatively, the address from the look-up unit can be forwarded, together with all or parts of the recorded information, to the recipient unit which uses the address in its management of the received information. Such an address obtained from the look-up unit can be a postal address, an e-mail address, a fax number, etc. In this case, the address of the recipient unit can, for example, be previously stored in the user unit's memory, or be calculated by the user unit on the basis of the recorded information, or be obtained from the look-up unit.

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

What we claim and desire to secure by Letters Patent is:

1. A system for information management, characterized by
a look-up unit (4; 302; 402) in which particulars are stored about a plurality of regions (5′; 101-120), each of which represents an area on at least one imaginary surface (5; 100) and is allocated an address, and
a user unit (2; 301; 401), which is arranged to record electronically information which comprises at least one position on the imaginary surface (5; 100); and to send said at least one position to the look-up unit (4; 302; 402),
the look-up unit (4; 302; 402) being arranged, in response to the receipt of said at least one position from the user unit (2; 301; 401), to identify to which region said at least one position belongs and to send the address which is allocated to the identified region to the user unit (2; 301; 401).

2. A system according to claim 1, in which each position is defined by at least two coordinates.

3. A system according to claim 1 or 2, in which the information recorded by the user unit (2; 301; 401) comprises a plurality of positions, of which only a first subset (311; 411) is sent to the look-up unit (4; 302; 402).

4. A system according to claim 1, 2 or 3, in which the user unit (2; 301; 401) is arranged, in response to the receipt of said address from the look-up unit (4; 302; 402), to send a second subset (351; 431) of the recorded information to said address.

5. A system according to claim 4, in which the second subset (351; 431) of the recorded information comprises a sequence of positions on the imaginary surface (5; 100), which positions create digital message information, such as interrelated lines.

6. A system according to any one of the preceding claims, in which the user unit (2; 301; 401) has a unique user identity (303; 403) and is arranged, in connection with the transmission of said at least one position, to send the user identity (303; 403) to the look-up unit (4; 302; 402).

7. A system according to any one of the preceding claims, in which the look-up unit (4; 302; 402) is arranged, in response to the receipt of said at least one position from the user unit (2; 301; 401), also to send to the user unit (2; 301; 401) a program file which is allocated to the identified region.

8. A system according to any one of the preceding claims, further comprising a base (1; 304, 404) on which said at least one position is recorded.

9. A system according to claim 8, in which the user unit (2; 301; 401) is arranged, upon recording of a command field (1F; 308; 406) on the base (1; 304, 404), to initiate transmission of all or parts of the recorded information.

10. A system according to claim 8 or 9, in which the imaginary surface (5; 100) consists of all the positions whose absolute coordinates a position-coding pattern has the capacity to code, in which at least one subset of the position-coding pattern is reproduced on the base (1; 304, 404), and in which the user unit (2; 301; 401) records said at least one position by means of said at least one subset of the position-coding pattern on the base (1; 304, 404).

11. A system according to claim 10, in which the recorded information contains message information (305; 407) which is written on a message field (1A, 1B; 306; 405) on the base (1; 304, 404) by means of the user unit (2; 301; 401), said message field (1A, 1B; 306; 405) containing a first subset of the position-coding pattern which codes positions within a first region on the imaginary surface (5; 100), which first region is dedicated to recording message information (305; 407) in the form of a sequence of positions on the imaginary surface (5; 100).

12. A system according to claim 11, in which the user unit (2; 301; 401) comprises at least one sensor (14) for recording message information (305; 407) on the message field (1A, 1B; 306; 405) and for recording the command field (1F; 308; 406).

13. A system according to claim 12, in which the user unit (2; 301; 401) comprises a single sensor (14) for the recording of the message information (305; 407) and the command field (1F; 308; 406), which sensor (14) is arranged to achieve the recording by recording said at least one subset of the position-coding pattern on the base (1; 304, 404).

14. A system according to claim 11, 12 or 13, in which the command field (1F; 308; 406) is provided with a second subset of the position-coding pattern which codes at least one position within a second region on the imaginary surface (5; 100), which second region is dedicated to initiating transmission of all or parts of the recorded information.

15. A system according to claim 14, in which the second region is dedicated to initiating in the user unit (2; 301; 401) transmission of all or parts of the recorded information to the look-up unit (4; 302; 402).

16. A system according to claim 14 or 15, in which the first region and/or the second region are allocated said address in the look-up unit (4; 302; 402).

17. A system according to claim 14, 15 or 16, in which the second subset of the position-coding pattern is located on a plurality of bases (1; 304, 404) and forms a universal command field (107) for transmission of information to the look-up unit (4; 302; 402).

18. A system according to claim 14, 15 or 16, in which the first and the second region are included in a primary main region (103) which is dedicated to transmission of information to the look-up unit (4; 302; 402).

19. A system according to claim 18, in which the main region (103) contains a plurality of identical standard regions (113), the first and the second regions being included in such a standard region (113).

20. A system according to claim 19, in which the user unit (2; 301; 401) stores particulars about said main region (103) and said standard region (113).

21. A system according to claim 20, in which the user unit (2; 301; 401) stores the second region as one or more positions within a standard region (113).

22. A system according to claim 19, 20 or 21, in which the position-coding pattern on the base (1; 304, 404) is a coherent part of said standard region (113).

23. A system according to any one of claims 19-22, in which the user unit (2; 301; 401) is arranged to send the information which is recorded on at least one of said standard regions (113) to said address.

24. A system according to any one of the preceding claims, in which said address identifies a recipient unit (6; 313; 413), such as a computer, a server unit, a mobile phone or a PDA.

25. A system according to any one of the preceding claims, in which the user unit (2; 301; 401) is arranged, in response to the receipt of said address from the look-up unit (4; 302; 402), to send said address to a recipient unit (6; 313; 413).

26. A system according to any one of the preceding claims, in which the look-up unit is a server unit (4; 302; 402) included in a computer network.

27. A system according to any one of the preceding claims, further comprising a network connection unit (3), such as mobile phone, a PDA, a cable-connected modem or a computer, the network connection unit (3) being arranged to connect the user unit (2) to the look-up unit (4).

28. A system according to claim 27, in which the network connection unit (3) is designed as a docking unit for receiving the user unit (2).

29. A look-up unit, which is arranged to be included in a system for information management, characterized in that the look-up unit has a memory (7) which stores particulars about a plurality of regions (5′), each of which corresponds to an area on an imaginary surface (5; 100) and is allocated an address, and that the look-up unit is arranged, in response to the receipt of at least one position from a user unit (2; 301; 401), to determine to which region said at least one position belongs, and to send an address which is allocated to the identified region to the user unit (2; 301; 401).

30. A look-up unit according to claim 29, which is arranged, in response to the receipt of said at least one position from the user unit (2; 301; 401), also to send to the user unit (2; 301; 401) a program file which is allocated to the identified region.

31. A look-up unit according to claim 29 or 30, which is a server unit (4; 302, 402) included in a computer network.

32. A user unit for electronic recording of information which comprises at least one position, characterized in that the user unit is arranged to send said at least one position to a look-up unit (4; 302; 402) for finding an address and to receive said address, and in response to the receipt of said address from the look-up unit (4; 302; 402), to send all or parts of the recorded information to said address.

33. A user unit according to claim 32, in which the information recorded by the user unit comprises a plurality of positions, of which only a first subset (311; 411) is sent to the look-up unit (4; 302; 402).

34. A user unit according to claim 32 or 33, which is arranged, in response to the receipt of said address from the look-up unit (4; 302; 402), to send a second subset (351; 431) of the recorded information to said address.

35. A user unit according to claim 34, in which the second subset (351; 431) of the recorded information comprises a sequence of positions on the imaginary surface (5; 100), which positions create digital message information (305; 407), such as interrelated lines.

36. A user unit according to any one of claims 32-35, which has a unique user identity (303; 403) and is arranged to send the user identity (303; 403) to the look-up unit (4; 302; 402) in connection with the transmission of said at least one position.

37. A user unit according to any one of claims 32-36, which consists of a hand-held device (2; 301; 401), such as a digital pen.

38. A computer program, characterized by instructions which cause a processor (7′), in response to the receipt of at least one position from a user unit (2; 301; 401), to determine to which of a plurality of regions, each of which corresponds to an area on an imaginary surface (5; 100), said at least one position belongs and to send an address which is allocated to the identified region to the user unit (2; 301; 401).

39. A method for management of information which comprises at least one position and which is recorded electronically by a user by means of a user unit (2; 301; 401), characterized in that
the user unit (2; 301; 401) sends said at least one position to a look-up unit (4; 302; 402),
on the basis of said at least one position, the look-up unit (4; 302; 402) identifies one of a plurality of regions on an imaginary surface (5; 100), about which the look-up unit (4; 302; 402) stores particulars and which is defined by a large number of positions,
on the basis of the identified region, the look-up unit (4; 302; 402) determines an address, and
the look-up unit (4; 302; 402) sends the determined address to the user unit (2; 301; 401).

40. A method according to claim 39, comprising the steps of the user unit (2; 301; 401) recording a plurality of positions which create said information, and the user unit (2; 301; 401) only sending a first subset (311; 411) of said plurality of positions to the look-up unit (4; 302; 402).

41. A method according to claim 40, comprising the step of the user unit (2; 301; 401) sending a second subset (351; 431) of the recorded information to said address, when it receives said address from the look-up unit (4; 302; 402).

42. A method according to claim 41, comprising the steps of said address and/or the second subset of the recorded information being at least partially displayed to the user, before the second subset (351; 431) is sent to said address, and the second subset (351; 431) being sent to said address after confirmation from the user.

43. A method according to any one of claims 39-42, comprising the steps of said information being recorded on a base (1; 304, 404) which is provided with at least one subset of a position-coding pattern which codes all the positions on the imaginary surface (5; 100), in which the user unit (2; 301; 401) records said at least one position using said at least one subset of the position-coding pattern on the base (1; 304, 404).

44. A method according to claim 43, comprising the step of initiating transmission of all or parts of the recorded information when the user unit (2; 301; 401) records a command field (1F; 308; 406) on the base (1; 304, 404).

45. A method according to claim 43 or 44, comprising the step of the user writing message information (305; 407) on a message field (1A, 1B; 306; 405) on the base (1; 304, 404), said message field (1A, 1B; 306; 405) containing a first subset of the position-coding pattern which codes positions within a first region on the imaginary surface (5; 100), which first region is dedicated to recording of message information in the form of a sequence of positions on the imaginary surface (5; 100).

46. A method according to claim 45, comprising the step of the user unit (2; 301; 401) initiating transmission of all or parts of the recorded information when it detects a second subset of the position-coding pattern which codes at least one position within a second region on the imaginary surface (5; 100), which second region is dedicated to initiating transmission of all or parts of the recorded information.
